(19) United States
(12) Patent Application Publication
(10) Pub. No.: US 2013/0268119 A1
(43) Pub. Date: Oct. 10, 2013

(54) SMARTPHONE AND INTERNET SERVICE ENABLED ROBOT SYSTEMS AND METHODS

(71) Applicant: TOVBOT, Atlanta, GA (US)

(72) Inventors: GIL WEINBERG, ATLANTA, GA (US); IAN CAMPBELL, SMYYRNA, GA (US); GUY HOFFMAN, TEL AVIV (IL); ROBERTO AIMI, PORTLAND, OR (US)

(21) Appl. No.: 13/661,507

(22) Filed: Oct. 26, 2012

Related U.S. Application Data
(60) Provisional application No. 61/552,610, filed on Oct. 28, 2011.

(51) Int. Cl. G05B 19/19

(52) U.S. Cl. CPC G05B 19/19
USPC 700/264

(57) ABSTRACT

Robots, robot systems, and methods may interact with users. Data from a sensor may be received by a processor associated with a robot. The processor may determine a user input based on the data from the sensor. The processor may send the user input to a remote service via a communication device. The processor may receive command data from the remote service via the communication device. The processor may cause an expressive element to perform an action corresponding to the command data.

### CROSS-REFERENCE TO RELATED APPLICATIONS

This application is based on and derives the benefit of the filing date of U.S. Provisional Patent Application No. 61/552,610, files Oct. 28, 2011. The entire content of U.S. Provisional Patent Application No. 61/552,610 is herein incorporated by reference in its entirety.

### FIELD OF THE INVENTION

This invention relates to robots and, more specifically, to robotic devices capable of interfacing to mobile devices like smartphones and to internet services.

### BACKGROUND OF THE INVENTION

A variety of known robotic devices respond to sound, light, and other environmental actions. These robotic devices, such as service robots, perform a specific function for a user. For example, a carpet cleaning robot can vacuum a floor surface automatically for a user without any direct interaction from the user. Known robotic devices have means to sense aspects of an environment, means to process the sensor information, and means to manipulate aspects of the environment to perform some useful function. Typically, the means to sense aspects of an environment, the means to process the sensor information, and the means to manipulate the environment are each part of the same robot body.

### SUMMARY

Systems and methods described herein pertain to robotic devices and robotic control systems that may be capable of sensing and interpreting a range of environmental actions, including audible and visual signals from a human. An example device may include a body having a variety of sensors for sensing environmental actions, a separate or joined body having means to process sensor information, and a separate or joined body containing actuators that produce gestures and signals proportional to the environmental actions. The variety of sensors and the means to process sensor information may be part of an external device such as a smartphone. The variety of sensors and the means to process sensor information may also be part of an external device such as a server connected to the internet.

Systems and methods described herein pertain to methods of sensing and processing environmental actions, and producing gestures and signals in proportional to the environmental actions. The methods may include sensing actions, producing electrical signals proportional to the environmental actions, processing the electrical signals, creating a set of actuator commands, and producing gestures and signals proportional to environmental actions.

### DETAILED DESCRIPTION OF THE FIGURES

These and other features of the preferred embodiments of the invention will become more apparent in the detailed description in which reference is made to the appended drawings wherein:

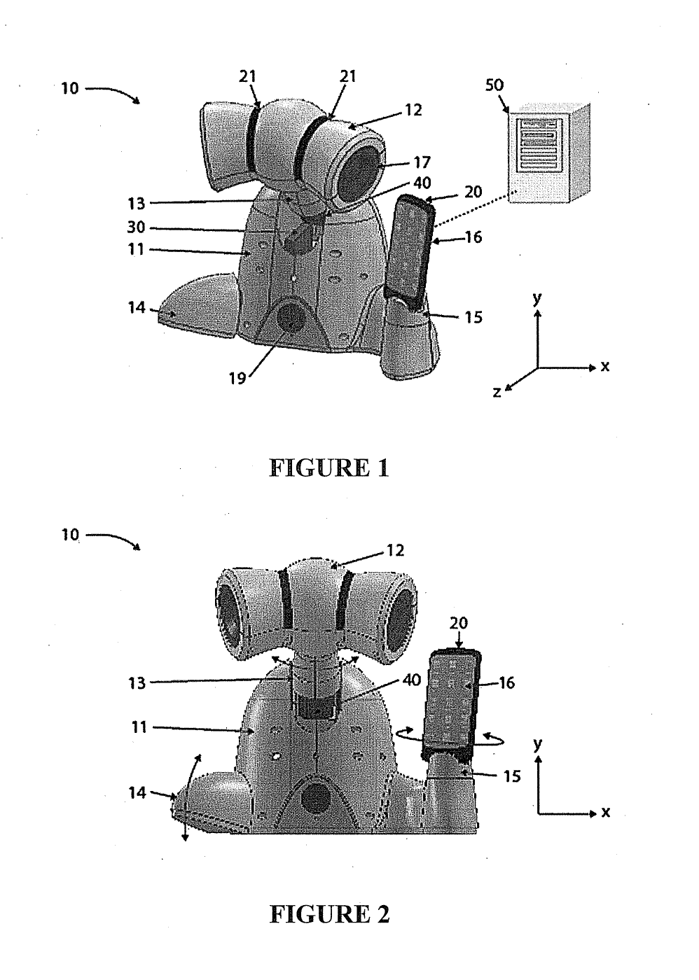

FIG. 1 is an isometric view of a robotic device according to an embodiment of the invention.

FIG. 2 is a front side view of a robotic device according to an embodiment of the invention.

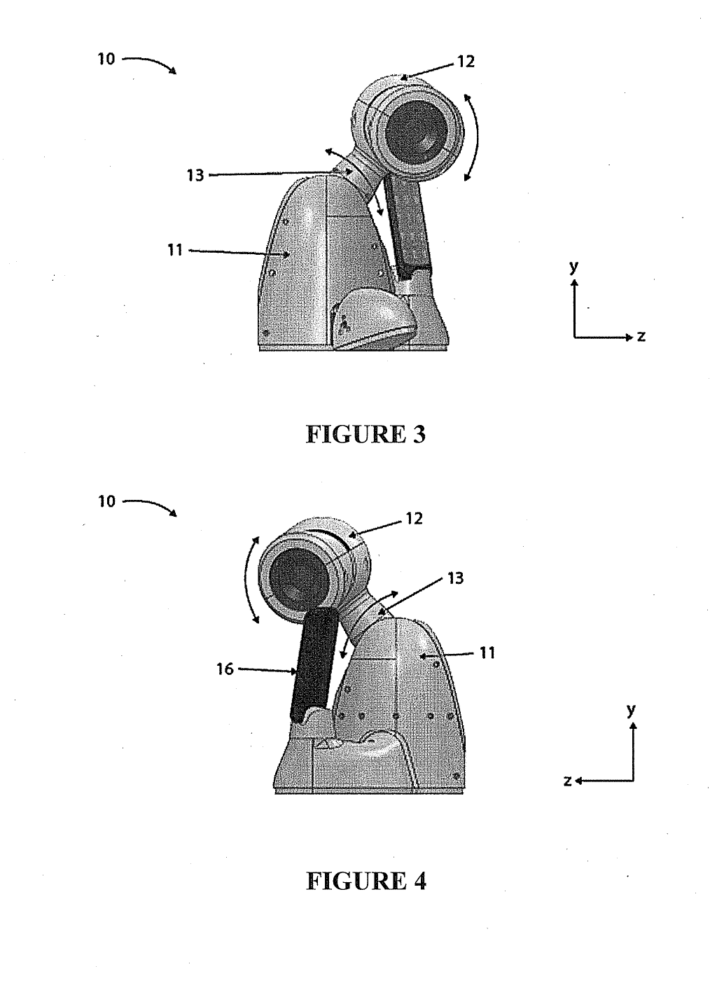

FIG. 3 is a right side view of a robotic device according to an embodiment of the invention.

FIG. 4 is a left side view of a robotic device according to an embodiment of the invention.

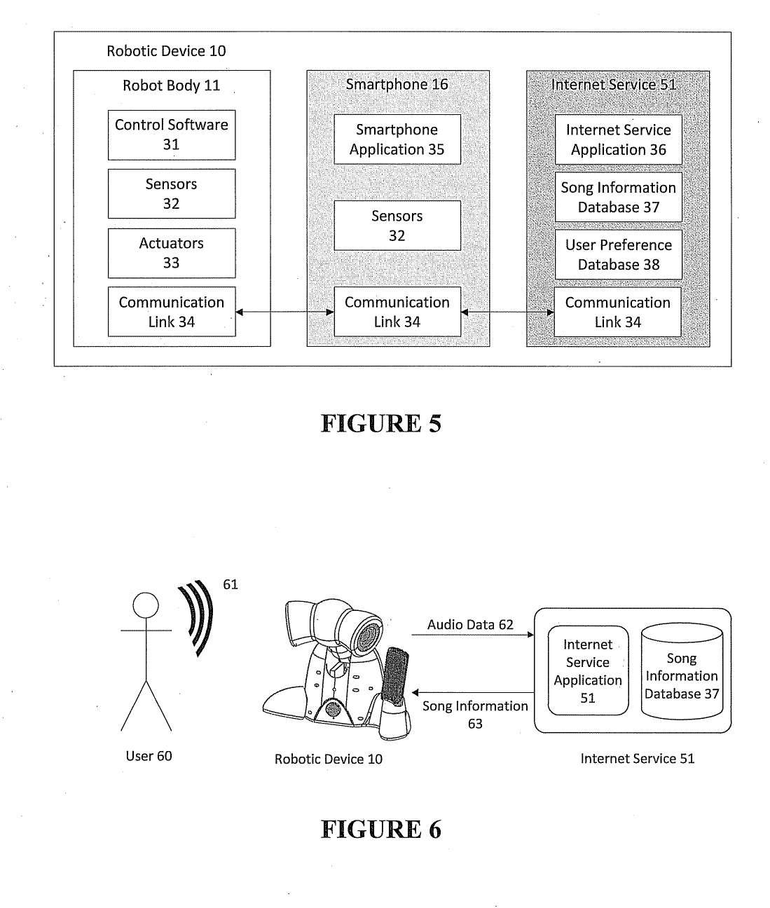

FIG. 5 is a schematic of a system architecture of a robotic device according to an embodiment of the invention.

FIG. 6 is a depiction of a use case of a robotic device according to an embodiment of the invention.

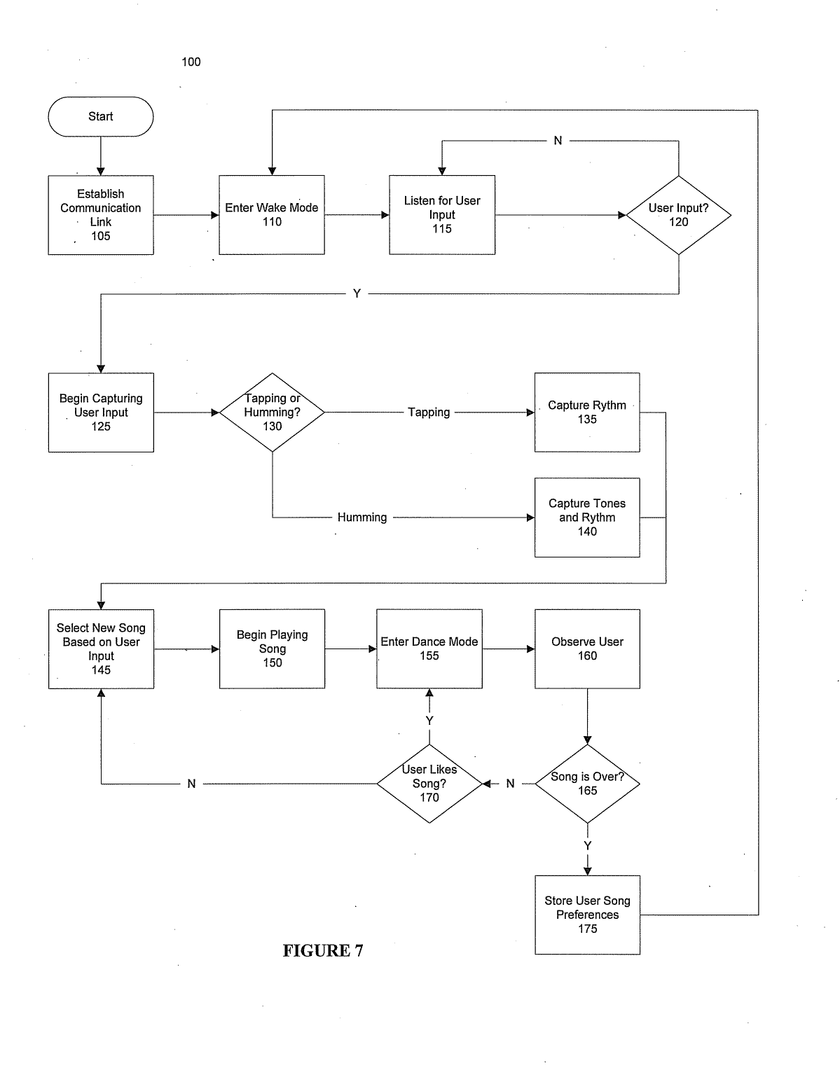

FIG. 7 is a control process for a robotic device according to an embodiment of the invention.

### DETAILED DESCRIPTION OF SEVERAL EMBODIMENTS

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting. The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof. Although the term “at least one” may often be used in the specification, claims and drawings, the terms “a”, “an”, “the”, “said”, etc. also signify “at least one” or “the at least one” in the specification, claims and drawings. Thus, for example, reference to “a pressure sensor” can include two or more such pressure sensors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

Systems and methods described herein may provide a robotic device that may be capable of sensing and interpreting a range of environmental actions and performing a function in response. For example, utilizing a real-time analysis of a user's auditory input and making use of online services that can translate audio into speech can provide a robot with the human-like ability to respond to human verbal speech commands. In other embodiments, different sensed data can be observed and analyzed and set to a remote service. The remote service can use this data to generate command data that may be sent back to the robotic device. The robotic device may use the command data to perform a task. Elements used to sense the environment, process the sensor information, and manipulate aspects of the environment may be separate from one another. In fact, each of these systems may be embodied on a separate device, such as a smartphone or a server connected to the internet.

The robotic device and robotic control system disclosed herein can be used in a variety of interactive applications. For example, the robotic device and control system can be used as an entertainment device that dances along with the rhythm and tempo of any musical composition.

Example systems and methods described herein may sense inputs such as dance gestures, drum beats, human created music, and/or recorded music, and perform a function such as producing gestures and signals in an entertaining fashion in response.

Additionally, systems and methods described herein may provide a robotic device capable of receiving and interpreting audio information. Human-robotic interaction may be enabled within the audio domain. Using sound as a method of communication rather than keyboard strokes or mouse clicks may create a more natural human-robot interaction experience, especially in the realm of music and media consumption. For example, by utilizing a real-time analysis of a user's auditory input and taking advantage of on-line databases containing relevant information about musical audio files available via the internet, it may be possible to match a human's audio input into a robotic device to a specific audio file or musical genre. These matches can be used to retrieve and playback songs that a user selects. A handful of applications that correlate audio input with existing songs exist which may be used with the specific processes and systems for human input to a robotic device's response within the context of human-robot interaction.

In yet another example, utilizing a real-time analysis of user visible input, such as facial expressions or physical gestures, and making use of off-line and on-line services that interpret facial expressions and gestures can provide a robot with the human-like ability to respond to human facial expressions or gestures.

In another example, the robotic device and robotic control system can be used as a notification system to notify a user of specific events or actions, such as when the user receives a status update on a social networking website, or when a timer has elapsed.

In another example, the robotic device and robotic control system can be used as remote monitoring system. In such a remote monitoring system, robotic device can be configured to remotely move the attached smartphone into an orientation where the video camera of the smartphone can be used to remotely capture and send video of the environment. In such a remote monitoring system, the robotic device can also be configured to remotely listen to audible signals from the environment and can be configured to alert a user when audible signals exceed some threshold, such as when an infant cries or a dog barks.

In another example, the robotic device and robotic control system can be used as an educational system. In such a system, the robotic device can be configured to present a set of possible answers, for example through a flash card or audio sequence, to a user and listen or watch for a user's correct verbal or visible response. In such a system, the robotic device can also be configured to listen as a user plays a musical composition on a musical instrument and provide positive or negative responses based on the user's performance.

In another example, the robotic device and robotic control system can be used as a gaming system. In such a system, the robotic device can be configured to teach a user sequences of physical gestures, such as rhythmic head bobbing or rhythmic hand shaking, facial expressions, such as frowning or smiling, audible actions, such as clapping, and other actions and provide positive or negative responses based on the user's performance. In such a system, the robotic device could also be configured to present the user a sequence of gestures and audio tones which the user must mimic in the correct order. In such a system, the robotic device could also be configured to present a set of possible answers to a question to the user, and the robotic device would provide positive or negative responses to the user based on the user's response.

The following detailed example discusses an embodiment wherein the robotic device and control system are used as an entertainment device that observes a user's audible input and plays a matching song and performs in response. Those of ordinary skill in the art will appreciate that the systems and methods of this embodiment may be applicable for other applications, such as those described above.

Several methods of human audio input can be used to elicit a musical or informative response from robotic devices. For example, human actions such as hand clapping can be used. In some robot learning algorithms, the examination of the real time audio stream of a human's hand clapping may be split into at least two parts: feature extraction and classification. An algorithm may pull from several signal processing and learning techniques to make assumptions about the human's tempo and style of the hand clapping. This algorithm may rely on the onset detection method described by Puckette, et al., “Real-time audio analysis tools for Pd and MSP”. Proceedings, International Music Conference. San Francisco: International Computer Music Association, pp. 109-112, 1998, for example, which measures the intervals between hand claps, autocorrelates the results, and processes the results through a comb filter bank as described by Davies, et al “Casual Tempo Tracking of Audio”, Proceedings of the 5th International Conference or Music Information Retrieval, pp. 164-169, 2004, for example. The contents of both of these articles are incorporated herein by reference in their entirety. Additionally, a quality threshold clustering to group the intervals can be used. From an analysis of these processed results a tempo may be estimated and/or a predicted output of future beats may be generated. Aside from onset intervals, information about specific clap volumes and intensities, periodicities, and ratios of clustered groups may reveal information about the clapping musical style such as rock, hip hop, or jazz. For example, an examination of a clapped sequence representative of a jazz rhythm may reveal that peak rhythmic energies fall on beats 2 and 4 whereas in a hip hop rhythm the rhythmic energy may be more evenly distributed. Clustering of the sequences also may show that the ratio of the number of relative triplets to relative quarter notes is greater in a jazzier sequence as opposed to the hip hop sequence which may have a higher relative sixteenth note to quarter note ratio. From the user's real-time clapped input, it may be possible to retrieve the tempo, predicted future beats, and a measure describing the likelihood of the input fitting a particular genre. This may enable “query by clapping” in which the user is able to request specific genres and songs by merely introducing a rhythmically meaningful representation of the desired output.

The robot systems and methods described herein may comprise one or more computers. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms is that are commonly used by those of ordinary skill in the relevant arts, such as servers, PCs, mobile devices, and other terms. Computers may facilitate communications between users, may provide databases, may perform analysis and/or transformation of data, and/or perform other functions. It will be understood by those of ordinary skill that those terms used herein are interchangeable, and any computer capable of performing the described functions may be used. For example, though the term “servers” may appear in the following specification, the disclosed embodiments are not limited to servers.

Computers may be linked to one another via a network or networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via WiFi, WiMax, or other wireless connection). Connections between computers may use any protocols, including connection oriented protocols such as TCP or connectionless protocols such as UDP. Any connection through which at least two computers may exchange data can be the basis of a network.

FIGS. 1-4 present several views of a robotic device 10 according to an embodiment of the invention. In one embodiment, a robotic device for sensing environmental actions such as dance gestures, drum beats, audible signals from a human, human created music, or recorded music, and performing a useful function, such as producing gestures and signals in an entertaining fashion may be provided.

As depicted in FIGS. 1 through 4, a robotic device 10 may comprise a variety of sensors for sensing environmental actions 20, a module configured to process sensor information 30, and a module configured to produce gestures and signals proportional to environmental actions 40. As those of ordinary skill in the art will appreciate, the module configured to process sensor information 30 and the module configured to produce gestures and signals proportional to environmental actions 40 may be elements of a single processor or computer, or they may be separate processors or computers.

The variety of sensors for sensing environmental actions 20, the module configured to process sensor information 30, and the module configured to produce gestures and signals proportional to environmental actions 40 may be contained within separate bodies, such as a smartphone 16 or other portable computer device, a server connected to the internet 50, and/or a robot body 11, in any combination or arrangement.

The robot body 11 may include various expressive elements which may be configured to move and/or activate automatically to interact with a user, as will be described in greater detail below. For example, the robot body 11 may include a movable head 12, a movable neck 13, one or more movable feet 14, one or more movable hands 15, one or more speaker systems 17, one or more lights 21, and/or any other features which may be automatically controlled to interact with a user.

FIG. 5 is a schematic of a system architecture of a robotic device 10 according to an embodiment of the invention. A robot body 11, such as the example described above, may include a computer configured to execute control software 31 enabling the computer to control elements of the robotic device 10. In some examples, this computer may be the same computer which comprises the module configured to process sensor information 30 and the module configured to produce gestures and signals proportional to environmental actions 40 described above. The robot body 11 may include sensors 32, which may be controlled by the computer and may detect user input and/or other environmental conditions as will be described in greater detail below. The robot body 11 may include actuators 33, which may be controlled by the computer and may be configured to move the various moving parts of the robot body 11, such as the movable head 12, movable neck 13, one or more movable feet 14, and/or one or more movable hands 15. For example, the actuators 33 may include, but are not limited to, an actuator to control foot 14 motion in the xy plane, an actuator to control neck 13 motion in the yz plane about an axis normal to the yz plane, an actuator to control neck 13 motion in about an axis normal to the xz plane, an actuator to control head 12 motion in the xy plane about an axis normal to the xz plane, and/or an actuator to control hand 15 motion about an axis normal to the xz plane. The robot body 11 may include a communication link 34, which may be configured to place the computer of the robot body 11 in communication with other devices such as a smartphone 16 and/or an internet service 51. The communication link 34 may be any type of communication link, including a wired or wireless connection.

A smartphone 16 or other computer device may be in communication with the robot body 11 via the robot body's communication link 34. The smartphone 16 may include a computer configured to execute one or more smartphone applications 35 or other programs which may enable the smartphone 16 to exchange sensor and/or control data with the robot body 11. In some embodiments, the module configured to process sensor information 30 and the module configured to produce gestures and signals proportional to environmental actions 40 may include the smartphone 16 computer and smartphone application 35, in addition to or instead of the computer of the robot body 11. The smartphone 16 may include sensors 32, which may be controlled by the computer and may detect user input and/or other environmental conditions as will be described in greater detail below. The smartphone 16 may include a communication link 34, which may be configured to place the computer of the smartphone 16 in communication with other devices such as the robot body 11 and/or an internet service 51. The communication link 34 may be any type of communication link, including a wired or wireless connection.

An internet service 51 may be in communication with the smartphone 16 and/or robot body 11 via the communication link 34 of the smartphone 16 and/or robot body 11. The internet service 51 may communicate via a network such as the internet using a communication link 34 and may comprise one or more servers. The servers may be configured to execute an internet service application 36 which may receive information from and/or provide information to the other elements of the robotic device 10, as will be described in greater detail below. The internet service 51 may include one or more databases, such as a song information database 37 and/or a user preference database 38. Examples of information contained in these databases 37, 38 are provided in greater detail below.

FIG. 6 is a depiction of a use case of a robotic device 10 according to an embodiment of the invention. A user 60 may generate audible signals 61, such as tapping or humming sounds. One or more sensors 32 may detect these sounds 61, and the module configured to process sensor information 30 may analyze them. The module configured to process sensor information 30 may execute an algorithm to process incoming audible signals 61 and correlate the audio signals 61 with known song patterns stored in a song information database 37 of an internet service 51. For example, audio data 62 generated from processing the audible signals may be sent to the internet service 51, and the internet service 51 may identify and return related song information 63 from the song information database 37. The returned song information 63 may be used by the control software 31 to produce commands which may produce gestures and signals proportional to environmental actions in the robot body 11. In some examples the system may be able to distinguish between rhythmic patterns, for example, but not limited to, a jazz rhythm, a hip hop rhythm, a rock and roll rhythm, a country western rhythm, or a waltz. In some examples the system may be able to distinguish between audio tones and patterns, for example, but not limited to, the notes of a popular song.

FIG. 7 is a control process 100 for a robotic device 10 according to an embodiment of the invention. The process 100 may begin when a user inserts a smartphone 16 into the hand 15 of the robot body 11 and creates a communication link 34, for example, but not limited to a USB communication link, or begins communication between the smartphone 16 and the robot body 11 with a wireless communication link, for example, but not limited to, a Bluetooth wireless communication link 105. Once communication between the smartphone 16 and the robot body 11 is established 105, the robot body 11 may enter a wake mode 110, wherein it may wait for commands from the smartphone 16. While waiting for commands from the smartphone 16, the robot body 11 may produce gestures and signals, for example, but not limited to, a breathing gesture, a looking and scanning gesture, an impatient gesture, flashing lights, and audible signals. The control software 31 may cause the actuators 33, lights 21, and/or speaker systems 17 to operate to produce these gestures and signals. The robot body 11 may use sensors 32 located on the robot body 11 and the smartphone 35 such as, but not limited to, the smartphone 35 camera, microphone, temperature sensor, accelerometer, light sensor, and other sensors to sense environmental actions 115 such as, but not limited to, human facial recognition and tracking, sound recognition, light recognition, and temperature changes.

When a user 60 creates additional environmental actions, for example, but not limited to, tapping a rhythm onto a surface, hand clapping, or humming, the robotic device may detect the environmental actions 120 and may begin capturing the user input 125 for interpretation. At this time, the robot body 11 may produce additional gestures and signals, for example, but not limited to, dancing gestures and audio playback through the speaker system 17.

The operating algorithm used by the robotic device 10 control software 31 and/or smartphone application 35 may interpret environmental actions such as, but not limited to, tapping a rhythm onto a surface, hand clapping, or humming, and may distinguish between tempos, cadences, styles, and genres of music using techniques such as those described by Puckette and Davies et. al 130. For example, the operating algorithm may distinguish between a hand clapped rhythm relating to a jazz rhythm, and a hand clapped rhythm relating to a hip hop rhythm. In cases wherein tapping, or some other input with no tonal variation, is detected, the system 10 may capture the rhythm of the signal 135. In cases wherein humming, or some other input with tonal variation, is detected, the system 10 may capture the tones and the rhythm of the signal 140.

Once the robot system 10 has detected the user input, it may select a song based on the user input 145. For example, this may be performed as described above with respect to FIG. 6, wherein audio data 62 is extracted and sent to an internet service 51, and song information 63 identifying the selected song is identified in a song information database 37. Once the song information 63 is received, the robot body's 11 speaker system 17 may begin playing the song 150. The robot body 11 may also enter a dance mode 155, wherein it may be controlled by the control software 11 to activate its actuators 33 and/or lights 21. The dance mode 155 actions of the robot body 11 may be performed to correspond to the rhythm and/or tone of the selected song. The robot system 10 may also observe the user 160 with its sensors 32. As long as the song plays 165, the system 10 may monitor whether the user likes the song 170. For example, the operating algorithm used by the robotic device 10 may interpret responses from the user 60, such as, but not limited to, the user's 60 motion in response to the gestures and signals produced by the robotic device 10. In this way, the system 10 may catalog user preferences such as, but not limited to, the songs that the user 60 most enjoys or songs that the user 60 does not enjoy. When the song ends 165, the user 60 preferences may be stored 175, for example in the user preference database 38 of the internet service 51. Also after the song ends 165, the device 10 may return to wake mode as described above 110 and await further user 60 input 115.

What is claimed is:

1. A robot comprising:
a robot body comprising an expressive element;
a processor in communication with the expressive element; and
a communication device disposed in the robot body and in communication with the processor, the communication device configured to establish a communication link with a mobile computing device; wherein
the processor is configured to:
receive data from a sensor;
determine a user input based on the data from the sensor;
send the user input to a remote service via the communication device;
receive command data from the remote service via the communication device; and
cause the expressive element to perform an action corresponding to the command data.

2. The robot of claim 1, wherein the processor is disposed in the robot body.

3. The robot of claim 1, wherein the expressive element comprises a movable part and an actuator, a speaker system, and/or a light element.

4. The robot of claim 3, wherein the movable part comprises a head, a neck, a foot, and/or a hand.

5. The robot of claim 1, wherein the processor is configured to determine the user input by:
determining a user input type based on the data from the sensor; and
determining musical data based on the user input type and the data from the sensor.

6. The robot of claim 5, wherein the user input type comprises a rhythmic user input and/or a rhythmic and tonal user input.

7. The robot of claim 6, wherein the processor is configured to determine the musical data by:
detecting a rhythm from the data from the sensor when the user input is a rhythmic user input; and
detecting a rhythm and tone determined from the data from the sensor when the user input is a rhythmic and tonal user input.

8. The robot of claim 1, wherein:
the command data comprises data identifying a song; and
the processor is configured to cause the expressive element to play the song.

9. The robot of claim 8, wherein the processor is further configured to cause the expressive element to perform an action when the song ends.

10. The robot of claim 1, wherein the processor is further configured to cause the expressive element to perform an action when the communication link with a mobile computing device is established.

11. The robot of claim 1, wherein the processor is further configured to analyze the data from the sensor to identify a positive user reaction and/or a negative user reaction.

12. The robot of claim 11, wherein the processor is further configured to:
cause the expressive element to perform a first action corresponding to the determined user reaction when the positive user reaction is identified; and
cause the expressive element to perform a second action corresponding to the determined user reaction when the negative user reaction is identified.

13. The robot of claim 12, wherein:
the second action comprises stopping play of a song; and
the processor is further configured to send the user input to the remote service via the communication device, receive new command data from the remote service via the communication device, and cause the expressive element to perform an action corresponding to the new command data when the negative user reaction is identified.

14. The robot of claim 11, wherein the processor is further configured to store a user preference based on the identified positive user reaction and/or negative user reaction.

15. The robot of claim 14, wherein the processor is configured to store the user preference by sending the user preference to the remote service.

16. A robot system comprising:
a robot body comprising:
a first processor;
an expressive element in communication with the first processor;
a speaker system; and
a first communication device in communication with the first processor;
a mobile computing device comprising:
a second processor; and
a second communication device in communication with the second processor, wherein the first communication device and the second communication device are configured to establish a communication link with one another; and
a sensor disposed in the robot body and/or the mobile computing device; wherein the first processor and/or the second processor is configured to:
receive data from the sensor;
determine a user input type based on the data from the sensor;
generate musical data based on the user input type and the data from the sensor;
send the musical data to a remote service;
receive data identifying a song from the remote service;
cause the speaker system to play the song; and
cause the expressive element to perform an action corresponding to the song.

17. The robot system of claim 16, wherein the expressive element comprises a movable part and an actuator and/or a light element.

18. The robot system of claim 16, wherein the movable part comprises a head, a neck, a foot, and/or a hand.

19. The robot system of claim 16, wherein the sensor is disposed in the robot body.

20. The robot system of claim 16, wherein the sensor is disposed in the mobile computing device.

21. The robot system of claim 16, wherein:
the sensor comprises an audio sensor and/or a video sensor; and
the data from the sensor comprises audio data and/or video data.

22. The robot system of claim 16, wherein the user input type comprises a rhythmic user input and/or a rhythmic and tonal user input.

23. The robot system of claim 22, wherein the first processor and/or the second processor is configured to generate the musical data by:
detecting a rhythm from the data from the sensor when the user input is a rhythmic user input; and
detecting a rhythm and tone determined from the data from the sensor when the user input is a rhythmic and tonal user input.

24. The robot system of claim 16, wherein the first processor and/or the second processor is further configured to cause the expressive element to perform an action when the communication link is established and/or when the song ends.

25. The robot system of claim 16, wherein the first processor and/or the second processor is further configured to analyze the data from the sensor when the song is playing to identify a positive user reaction and/or a negative user reaction.

26. The robot system of claim 25, wherein the first processor and/or the second processor is further configured to:
cause the expressive element to perform an action corresponding to the determined user reaction when the positive user reaction is identified; and
stop the song, send the musical data to the remote service, receive data identifying a second song from the remote service, cause the speaker system to play the second song, and cause the expressive element to perform an action corresponding to the second song when the negative user reaction is identified.

27. The robot system of claim 25, wherein the first processor and/or the second processor is further configured to store a user song preference based on the identified positive user reaction and/or negative user reaction.

28. The robot system of claim 27, wherein the first processor and/or the second processor is configured to store the user song preference by sending the user song preference to the remote service.

29. The robot system of claim 16, further comprising the remote service, the remote service comprising:
a song information database;
a third communication device configured to communicate with the first communication device and/or the second communication device; and
a third processor in communication with the song information database and the third communication device, the third processor being configured to:
receive the musical data via the third communication device;
analyze the musical data to identify a song associated with the musical data;
retrieve the data identifying the song from the song information database; and
cause the third communication device to send the data identifying the song to the first communication device and/or the second communication device.

30. The robot system of claim 29, wherein:
the remote service further comprises a user preference database in communication with the third processor; and
the third processor is further configured to receive a user song preference via the third communication device and store the user song preference in the user preference database.

31. A method comprising:
receiving, with a processor associated with a robot, data from a sensor;
determining, with the processor, a user input based on the data from the sensor;
sending, with the processor, the user input to a remote service via a communication device;
receiving, with the processor, command data from the remote service via the communication device; and
causing, with the processor, an expressive element to perform an action corresponding to the command data.

32. The method of claim 31, wherein causing the expressive element of the robot to perform an action comprises causing an actuator to move a movable part, causing a speaker system to produce an audio signal, and/or lighting a light element.

33. The method of claim 32, wherein the movable part comprises a head, a neck, a foot, and/or a hand.

34. The method of claim 31, wherein the data from the sensor comprises audio data and/or video data.

35. The method of claim 31, wherein determining the user input comprises:
determining a user input type based on the data from the sensor; and
determining musical data based on the user input type and the data from the sensor.

36. The method of claim 35, wherein the user input type comprises a rhythmic user input and/or a rhythmic and tonal user input.

37. The method of claim 36, wherein determining the musical data comprises:
detecting a rhythm from the data from the sensor when the user input is a rhythmic user input; and
detecting a rhythm and tone determined from the data from the sensor when the user input is a rhythmic and tonal user input.

38. The method of claim 31, wherein:
the command data comprises data identifying a song; and
causing the expressive element to perform the action comprises causing the expressive element to play the song.

39. The method of claim 38, further comprising causing the expressive element to perform an action when the song ends.

40. The method of claim 31, further comprising:
detecting, with the processor, establishment of a communication link between a robot body associated with the robot and a mobile computing device associated with the robot; and
causing, with the processor, the expressive element to perform an action when the communication link is detected.

41. The method of claim 31, further comprising analyzing, with the processor, the data from the sensor to identify a positive user reaction and/or a negative user reaction.

42. The method of claim 41, further comprising:
causing, with the processor, the expressive element to perform a first action corresponding to the determined user reaction when the positive user reaction is identified; and
causing, with the processor, the expressive element to perform a second action corresponding to the determined user reaction when the negative user reaction is identified.

43. The method of claim 42, wherein:
the second action comprises stopping play of a song; and
the method further comprises sending, with the processor, the user input to the remote service via the communication device, receiving, with the processor, new command data from the remote service via the communication device, and causing, with the processor, the expressive element to perform an action corresponding to the new command data when the negative user reaction is identified.

44. The method of claim 41, further comprising storing, with the processor, a user preference based on the identified positive user reaction and/or negative user reaction.

45. The method of claim 44, wherein storing the user preference comprises sending the user preference to the remote service.

46. The method of claim 31, wherein the processor comprises a first processor disposed in a robot body associated with the robot and/or a second processor disposed in a mobile computing device associated with the robot.
